(19) United States
(12) Patent Application Publication
(10) Pub. No.: US 2018/0335000 A1
(43) Pub. Date: Nov. 22, 2018

(54) INTAKE DUCT FOR INTERNAL COMBUSTION ENGINE

(71) Applicant: TOYOTA BOSHOKU KABUSHIKI KAISHA, Aichi (JP)

(72) Inventor: Ryusuke KIMURA, Ichinomiya-shi (JP)

(73) Assignee: TOYOTA BOSHOKU KABUSHIKI KAISHA, Aichi (JP)

(21) Appl. No.: 15/975,219

(22) Filed: May 9, 2018

(30) Foreign Application Priority Data
May 22, 2017 (JP) 2017-100737

(51) Int. Cl. F02M 35/10; B32B 5/02

(52) U.S. Cl. CPC F02M 35/10098; B32B 2037/1223; B32B 2262/0284; B32B 5/022

(57) ABSTRACT

An intake duct for an internal combustion engine includes a cylindrical duct main body. The duct main body includes an inner layer and an air-impermeable sheet. The inner layer is made of an air-permeable first fiber molding and constitutes the inner circumferential surface of the duct main body. The air-impermeable sheet is fixed to the outer circumferential surface of the inner layer. The weight per unit area of the sheet is 15 to 100 g/m².

### BACKGROUND

The present invention relates to an intake duct for an internal combustion engine.

Japanese Laid-Open Patent Publication No. 11-343939 discloses an intake duct for an internal combustion engine that is formed through compression molding of a nonwoven fabric containing thermoplastic resin binder. The inlet duct of the publication has hard portions of a high compression ratio and soft portions of a low compression ratio. In the intake duct of the publication, at least part of the wall is formed by a soft portion, which has a certain degree of air permeability. Thus, some of the sound wave of the intake air passes through the soft portion. This suppresses the generation of a standing wave of the sound wave of the intake air, thereby reducing the intake noise.

External air is drawn into the intake duct of the publication by the negative pressure in the intake pipe of the internal combustion engine. This increases the thickness of the boundary layer formed in the vicinity of the inner circumferential surface of the intake duct, that is, the thickness of the layer in which the viscosity of the intake air is not negligible. Accordingly, the airflow resistance of the main flow of intake air flowing through the intake duct is increased.

### SUMMARY

Accordingly, it is an objective of the present invention to provide an intake duct for an internal combustion engine that is capable of limiting the increase in the airflow resistance of intake air and reducing the intake noise.

To achieve the foregoing objective, an intake duct for an internal combustion engine is provided. The intake duct includes a cylindrical duct main body. The duct main body includes an inner layer, which is made of an air-permeable first fiber molding and constitutes an inner circumferential surface of the duct main body, and an air-impermeable sheet, which is fixed to an outer circumferential surface of the inner layer. A weight per unit area of the sheet is 15 to 100 g/m².

### BRIEF DESCRIPTION OF THE DRAWINGS

FIG. 1 is a perspective view showing an entire intake duct for an internal combustion engine according to one embodiment.

FIG. 2 is a longitudinal cross-sectional view showing the intake duct of the embodiment.

FIG. 3 is a perspective view showing a first half body of the embodiment as seen from inside.

FIG. 4 is a transverse cross-sectional view illustrating the first half body of the embodiment.

FIG. 5 is a cross-sectional view showing the cross-sectional structure of the wall of the duct main body of the embodiment.

FIG. 6 is a cross-sectional view showing the cross-sectional structure of the wall of a duct main body of a modification.

### DETAILED DESCRIPTION OF THE PREFERRED EMBODIMENTS

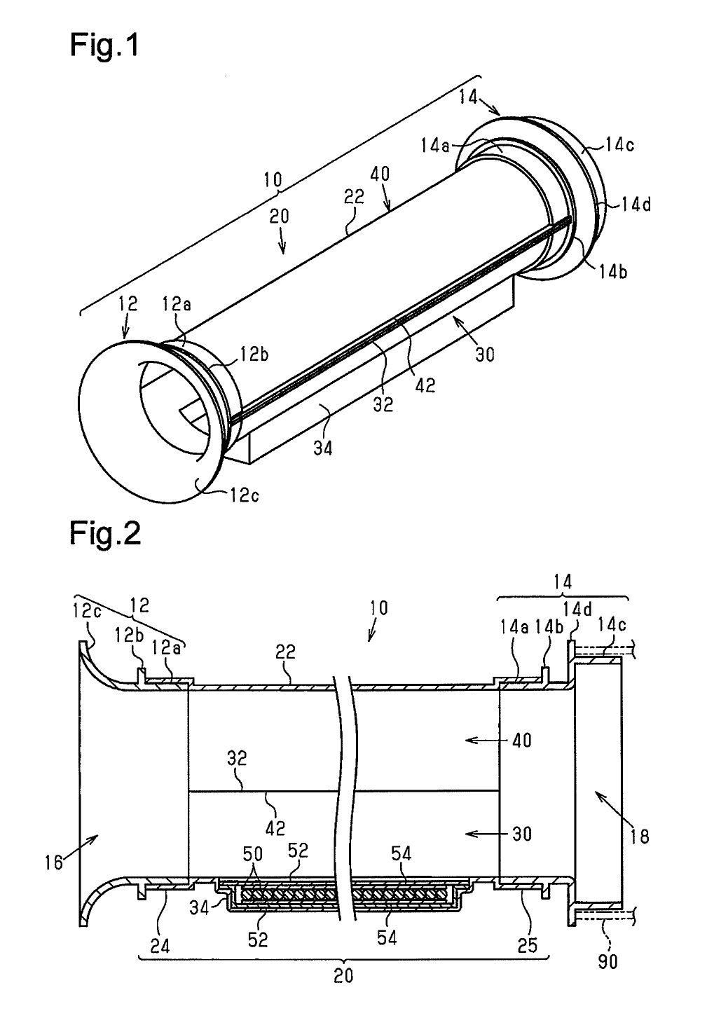

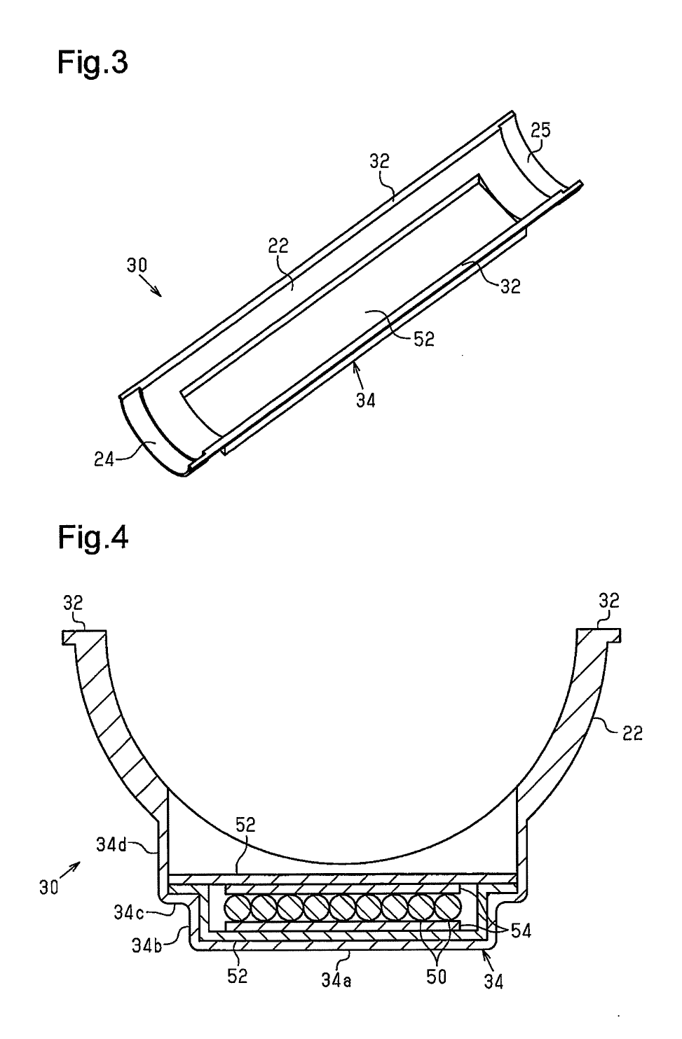

One embodiment will now be described with reference to FIGS. 1 to 5.

As shown in FIGS. 1 and 2, an intake duct 10 for an internal combustion engine includes an upstream-side connecting member 12, a duct main body 20, and a downstream-side connecting member 14. The intake duct 10 is connected to an inlet 90 of an air cleaner represented by the long dashed double-short dashed lines in FIG. 2 and constitutes a part of the intake passage.

In the following description, the upstream side and the downstream side in the flow direction of intake air in the intake duct 10 are simply referred to as an upstream side and a downstream side, respectively.

<Upstream-Side Connecting Member 12>

As shown in FIGS. 1 and 2, the upstream-side connecting member 12 is made of a hard plastic and cylindrical and constitutes an entrance 16 of the intake duct 10. The upstream-side connecting member 12 includes a cylindrical connecting portion 12a, an annular protrusion 12b, and a funnel portion 12c. The protrusion 12b protrudes from the outer circumferential surface of the connecting portion 12a. The funnel portion 12c is connected to the upstream end of the connecting portion 12a and has a recurved shape such that it extends radially outward toward the upstream side.

<Downstream-Side Connecting Member 14>

As shown in FIGS. 1 and 2, the downstream-side connecting member 14 is made of a hard plastic and cylindrical and constitutes an exit 18 of the intake duct 10. The downstream-side connecting member 14 includes a cylindrical connecting portion 14a, an annular protrusion 14b, a cylindrical large-diameter portion 14c, and an annular contact portion 14d. The protrusion 14b protrudes from the outer circumferential surface of the connecting portion 14a. The large-diameter portion 14c is coaxially connected to the downstream end of the connecting portion 14a. The large-diameter portion 14c has a larger inner diameter and a larger outer diameter than those of the connecting portion 14a. The contact portion 14d protrudes from the outer circumferential surface of the boundary between the connecting portion 14a and the large-diameter portion 14c.

In a state in which the downstream-side connecting member 14 is connected to the inlet 90 as shown in FIG. 2, the large-diameter portion 14c is inserted into the inlet 90 and the distal end of the inlet 90 contacts the contact portion 14d.

<Duct Main Body 20>

As shown in FIGS. 1 and 2, the duct main body 20 includes a first half body 30 and a second half body 40, each of which has the shape of a half cylinder.

The first half body 30 has a pair of joint portions 32 at the opposite ends in the circumferential direction. The joint portions 32 extend throughout the length in the axial direction. The second half body 40 has a pair of joint portions 42 at the opposite ends in the circumferential direction. The joint portions 42 extend throughout the length in the axial direction. The joint portions 32 of the first half body 30 and the joint portions 42 of the second half body 40 are joined together to form the cylindrical duct main body 20.

The duct main body 20 includes a body portion 22 and end portions 24, 25 provided on the opposite sides in the axial direction of the body portion 22. The end portions 24, 25 each have a larger inner diameter and a larger outer diameter than those of the body portion 22.

As shown in FIG. 2, the connecting portion 12a of the upstream-side connecting member 12 is inserted into the upstream end portion 24 of the duct main body 20. The outer circumferential surface of the connecting portion 12a and the inner circumferential surface of the end portion 24 are joined with adhesive. The end portion 24 abuts against the protrusion 12b.

The connecting portion 14a of the downstream-side connecting member 14 is inserted into the downstream end portion 25 of the duct main body 20. The outer circumferential surface of the connecting portion 14a and the inner circumferential surface of the end portion 25 are joined with adhesive. The end portion 25 abuts against the protrusion 14b.

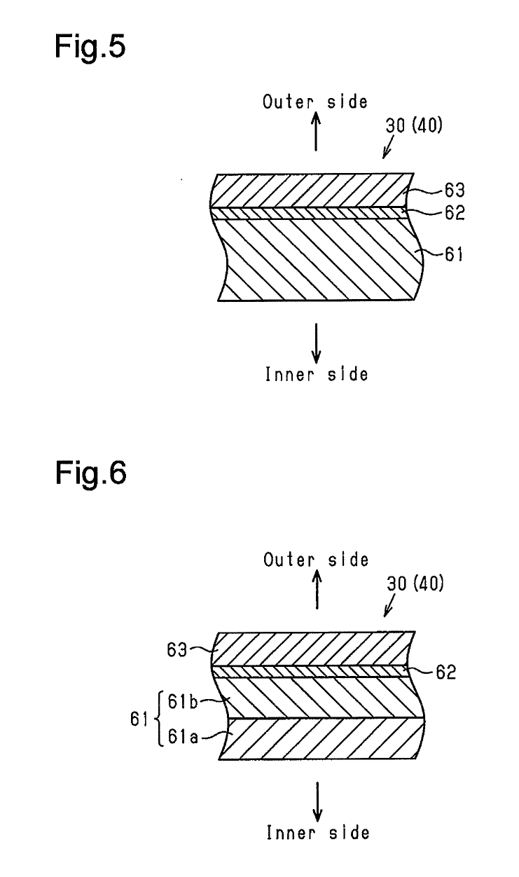

As shown in FIG. 5, each of the half bodies 30, 40 includes an air-permeable inner layer 61, an air-impermeable film 62, and an air-permeable outer layer 63. The inner layer 61 is made of an air-permeable first nonwoven fabric molding and constitutes the inner circumferential surface of the duct main body 20. The film 62 is fixed to the outer circumferential surface of the inner layer 61. The outer layer 63 is made of an air-permeable second nonwoven fabric molding and is fixed to the outer circumferential surface of the film 62 to protect the film 62.

Next, the structures of the inner layer 61, the film 62, and the outer layer 63 will be described.

<Inner Layer 61>

The first nonwoven fabric, which constitutes the inner layer 61, is composed of known sheath-core bicomponent fibers including cores (not shown) made of, for example, polyethylene terephthalate (PET) and sheaths (not shown) made of a modified PET having a melting point lower than that of the PET. The modified PET functions as a binder that binds the PET together.

The mixing ratio of the modified PET is preferably between 30 to 70% inclusive. In the present embodiment, the mixing ratio of the modified PET is set to 50%.

The bicomponent fibers may have cores (not shown) made of PET and sheaths (not shown) made of polypropylene (PP) having a melting point lower than that of PET.

The weight per unit area of the first nonwoven fabric is preferably 500 to 1500 g/m². In the present embodiment, the weight per unit area of the first nonwoven fabric is set to 800 g/m².

The air permeability (as defined in JIS L 1096, A-method (Frazier method)) of part of the inner layer 61 that constitutes the body portion 22 is set to 3 cm³/cm²·s.

On the other hand, the air permeability of part of the inner layer 61 that constitutes each of the joint portions 32, 42 is set to approximately 0 cm³/cm²·s.

<Film 62>

The film 62 functions as a sheet according to the present invention and is composed of a body layer and two adhesive layers provided on the opposite surfaces of the body layer. The body layer is made of, for example, nylon. The adhesive layers are made of polyethylene having a lower melting point than those of PET and modified PET and function as adhesive for bonding the film 62 to the inner layer 61 and the outer layer 63.

The film 62 is fixed to the entire outer circumferential surface of the inner layer 61.

The weight per unit area of the film 62 is 15 to 100 g/m². In the present embodiment, the weight per unit area of the film 62 is set to 45 g/m².

<Outer Layer 63>

The second nonwoven fabric, which constitutes the outer layer 63, is composed of, for example, PET fibers.

The fibers constituting the second nonwoven fabric may be sheath-core bicomponent fibers including cores made of PET and sheaths made of a modified PET having a melting point lower than that of the PET as in the case of the inner layer 61. In this case, the modified PET preferably constitutes 70% or less. In addition, instead of the modified PET, the sheaths may be constituted by PP.

The weight per unit area of the second nonwoven fabric is preferably 30 to 300 g/m². In the present embodiment, the weight per unit area of the second nonwoven fabric is set to 70 g/m².

The thickness of the body portion 22 of each of the half bodies 30, 40 is preferably from 0.8 to 3.0 mm. In the present embodiment, the thickness of this part is set to 1.0 mm.

Each of the joint portions 32, 42 is compressed at a higher compression ratio than the body portion 22, and the thickness of each of the joint portions 32, 42 is less than the thickness of the body portion 22. The thickness of each of the joint portions 32, 42 is preferably from 0.5 to 1.5 mm. In the present embodiment, the thickness of the joint portions 32, 42 is set to 1.0 mm.

As shown in FIGS. 1 to 4, the first half body 30 has an accommodation portion 34, which bulges outward from the body portion 22.

As shown in FIGS. 2 and 4, the accommodation portion 34 includes a bottom wall portion 34a, which has a substantially rectangular shape in a plan view, an upright wall portion 34b, which is located at the periphery of the bottom wall portion 34a and extends upward, a fixing portion 34c, which extends outward from the upper end of the upright wall portion 34b, and a side wall portion 34d, which is located at the periphery of the fixing portion 34c and is connected to the body portion 22.

The bottom wall portion 34a, the upright wall portion 34b, the fixing portion 34c, and the side wall portion 34d are all compressed at the same compression ratio as the end portions 24, 25 and the joint portions 32, 42.

The accommodation portion 34 accommodates an adsorbent 50 that adsorbs fuel vapor of the internal combustion engine.

The adsorbent 50 is preferably, for example, activated carbon particles. The adsorbent 50 is sandwiched between two glass fiber nets 54 and further sandwiched between two holding sheets 52.

A third nonwoven fabric, which constitutes the holding sheets 52, is composed of, for example, modified PET fibers.

The third nonwoven fabric may be composed of known sheath-core bicomponent fibers including cores made of, for example, PET and sheaths made of a modified PET having a melting point lower than that of the PET of the cores or PP.

The weight per unit area of the third nonwoven fabric is preferably 30 to 150 g/m². In the present embodiment, the weight per unit area of the third nonwoven fabric is set to 60 g/m².

The thickness of each holding sheet 52 is preferably from 0.1 to 1.5 mm. In the present embodiment, the thickness of each holding sheet 52 is set to 0.3 mm.

The two holding sheets 52, which hold the adsorbent 50 and the two glass fiber nets 54, are placed on the bottom wall portion 34a of the accommodation portion 34, and the edges of the holding sheets 52 are placed on the fixing portion 34c. In this state, the edges of the holding sheets 52 are fixed to the fixing portion 34c by ultrasonic welding.

Each of the half bodies 30, 40 is formed by heating and press-molding the laminate constituted by the first nonwoven fabric, which is the material of the inner layer 61, the second nonwoven fabric, which is the material of the outer layer 63, and the film 62 arranged between the first and second nonwoven fabrics.

An operation of the present embodiment will now be described.

The inner layer 61, which constitutes the inner circumferential surface of the duct main body 20 of the intake duct 10, is made of the air-permeable first nonwoven fabric molding (a first fiber molding). Thus, when the intake sound in the intake duct 10 passes through the inner layer 61, some of the pressure of the intake sound (sound pressure) vibrates the fibers to be converted into thermal energy. This suppresses the generation of a standing wave of the intake sound, thereby reducing the intake noise.

Further, since the air-impermeable film 62 is fixed to the outer circumferential surface of the inner layer 61, external air is not drawn in through the wall of the duct main body 20. This prevents the increase in the thickness of the boundary layer formed in the vicinity of the inner circumferential surface of the duct main body 20, that is, the thickness of the layer in which the viscosity of the intake air is not negligible. Accordingly, it is possible to limit the increase in the airflow resistance of the main flow of intake air flowing through the intake duct 10.

Since the weight per unit area of the film 62 is 100 g/m² or less, the intake sound having passed through the inner layer 61 passes through the film 62. Therefore, by providing the air-impermeable film 62, the transmission of the intake sound is not hindered, and the above-described noise reduction effect can be exerted.

In addition, since the weight per unit area of the film 62 is 15 g/m² or more, the strength of the film 62 is ensured, so that breakage of the film 62 is reliably avoided.

The intake duct for an internal combustion engine according to the above-described embodiment has the following advantages.

(1) The duct main body 20 of the intake duct 10 includes the inner layer 61, which is made of the air-permeable first fiber molding and constitutes the inner circumferential surface of the duct main body 20, and the air-impermeable film 62 (sheet), which is fixed to the outer circumferential surface of the inner layer 61. The weight per unit area of the film 62 is 15 to 100 g/m².

This configuration achieves the above-described operation and thus reduces the intake noise while suppressing the increase in the airflow resistance of the intake air (advantage 1).

(2) The film 62 is entirely fixed to the outer circumferential surface of the inner layer 61.

Although the weight per unit area of the film 62 is sufficiently small, when a part of the film 62 is not fixed to the inner layer 61, the sound pressure of the intake sound having passed through the inner layer 61 causes the part of the film 62 that is not fixed to the inner layer 61 to resonate. The frequency of the intake sound that causes the film 62 to resonate is determined in accordance with the area of the part of the film 62 that is not fixed to the inner layer 61. Therefore, the component of this frequency in the intake sound cannot pass through the film 62, and it is difficult to obtain the intake noise reduction effect.

In this respect, according to the above-described configuration, the entire film 62 is fixed to the outer circumferential surface of the inner layer 61. Thus, the resonance of the film 62 as described above is reliably prevented, and the above advantage 1 is reliably achieved.

(3) The duct main body 20 further includes the air-permeable outer layer 63, which is arranged on the outer circumferential surface of the film 62 and protects the film 62.

According to such a configuration, since the film 62 is protected by the air-permeable outer layer 63, breakage of the film 62 is reliably prevented. In addition, since the intake sound passing through the film 62 passes through the outer layer 63, the above-described advantage 1 is reliably achieved.

(4) The outer layer 63 is composed of the second nonwoven fabric molding (the second fiber molding). Therefore, the air-permeable outer layer 63 can be easily obtained.

(5) The inner layer 61 and the outer layer 63 are made of materials having higher melting points than that of the film 62.

For example, if the duct main body 20 does not have the outer layer 63, the laminate is formed by laminating the film 62 and the nonwoven fabric that is the material of the inner layer 61. If the inner layer 61 is made of a material having a melting point higher than that of the film 62, it is necessary to employ a heat-resistant film so as to avoid melting of the film 62 when heating and molding the laminate.

In this respect, according to the above-described configuration, when heating and molding the laminate constituted by the first nonwoven fabric, which is the material of the inner layer 61, the second nonwoven fabric, which is the material of the outer layer 63, and the film 62, which is arranged between the first and second nonwoven fabrics, the outer layer 63 protests the film 62 from the heat. Therefore, it is unnecessary to use a heat-resistant film, reducing the manufacturing costs of the intake duct 10.

<Modifications>

The above-described embodiment may be modified as follows.

As shown in FIG. 6, the first nonwoven fabric molding constituting the inner layer 61 may be formed of two laminated nonwoven fabrics 61a, 61b. In general, the nonwoven fabric becomes more expensive as the weight per unit area increases. In this regard, if the first nonwoven fabric molding, which constitutes the inner layer 61, is formed by the two nonwoven fabrics 61a, 61b, it is possible to reduce the weight per unit area of each nonwoven fabric, reducing the manufacturing costs of the intake duct 10. The first nonwoven fabric molding, which constitutes the inner layer 61, can also be formed of three or more laminated nonwoven fabrics.

The outer layer 63 can be omitted. In this case, it only requires using a heat-resistant film.

The inner layer 61 and the outer layer 63 may be formed by woven fabric moldings.

The sheet according to the present invention is not limited to the film 62. The sheet may be, for example, an air-impermeable film applied to the outer circumferential surface of the inner layer 61, that is, a coating film.

1. An intake duct for an internal combustion engine comprising a cylindrical duct main body, wherein
the duct main body includes
an inner layer, which is made of an air-permeable first fiber molding and constitutes an inner circumferential surface of the duct main body, and
an air-impermeable sheet, which is fixed to an outer circumferential surface of the inner layer, and
a weight per unit area of the sheet is 15 to 100 g/m².

2. The intake duct for an internal combustion engine according to claim 1, wherein the duct main body further includes an air-permeable outer layer, which is arranged on an outer circumferential surface of the sheet and protects the sheet.

3. The intake duct for an internal combustion engine according to claim 2, wherein the outer layer is made of a second fiber molding.

4. The intake duct for an internal combustion engine according to claim 2, wherein that the inner layer and the outer layer are made of a material having a higher melting point than that of the sheet.

5. The intake duct for an internal combustion engine according to claim 1, wherein the first fiber molding is formed of two or more laminated nonwoven fabrics.
